(19) United States
(12) Patent Application Publication
(10) Pub. No.: US 2014/0054830 A1
(43) Pub. Date: Feb. 27, 2014

(54) Fiber resin duct

(71) Applicant: Deutsches Zentrum fuer Luft- und Raumfahrt e.V., Koeln (DE)

(72) Inventors: Arne Hindersmann, Stade (DE); Michael Kuehn, Hollern-Twielenfleth (DE); Jens Ramon Boelke, Stade (DE)

(73) Assignee: Deutsches Zentrum fuer Luft- und Raumfahrt e.V., Koeln (DE)

(21) Appl. No.: 13/973,387

(22) Filed: Aug. 22, 2013

(30) Foreign Application Priority Data
Aug. 24, 2012 (DE) 10 2012 107 820.3

(51) Int. Cl. B29C 70/02

(52) U.S. Cl. CPC B29C 70/023
USPC 264/570; 425/129.1

(57) ABSTRACT

The invention relates to a method and a device for manufacturing a fiber-composite component, in which a closed U-shaped profile is placed onto the vacuum film and subsequently the cavity formed there is evacuated in order to form in this manner natural resin flow paths in the semifinished fiber product.

The invention relates to a method for the manufacturing of a fiber-composite component, in which a semifinished fiber product is inserted into a molding tool and the semifinished fiber product is then closed by a vacuum film in a vacuum-tight manner, such that an injection region with the semifinished fiber product is formed between molding tool and vacuum film, the injection region being evacuated by means of a pressure sink and subsequently being injected with a matrix resin in order to infiltrate the semifinished fiber product in the injection region with the matrix resin.

An often-used method for the manufacturing of fiber-composite components is what is referred to as RTM (resin transfer molding). Here, a dry or pre-impregnated semifinished fiber product is injected with a matrix resin until the semifinished fiber product is completely infiltrated or impregnated with the matrix resin. After the complete infiltration, the matrix resin is cured mostly under correspondingly temperature-controlled conditions.

In order to favorably influence important process parameters, the semifinished fiber product introduced into a molding tool is sealed with a vacuum film and subsequently evacuated, such that the resin distribution process inside the semifinished fiber product is promoted on the one hand, and air pockets in the semifinished fiber product, which may later lead to defects in the finished component, are avoided on the other hand. At the same time, the entire process is autoclave-compatible, on account of which the evacuation and injecting of the matrix resin can be carried out within the autoclave. Hence the ambient pressure can be additionally increased, which furthermore has a favorable effect on the infiltration process.

From EP 1 131 195 B1, for example, a device for the manufacturing of a fiber-reinforced polymer is known in which the mold to be manufactured is introduced into an autoclave prior to the actual manufacturing process. Here, the mold is connected to a common line for evacuating the mold and also for the injection of the resin, wherein the storage container, which provides the matrix resin to be injected, is connected to the autoclave via a pressure transfer line for the purpose of pressure equalization.

When manufacturing comparatively large components using this technology, there is, however, the disadvantage that the flow paths of the matrix resin within the semifinished fiber product become very long, such that it is necessary for lengths upward of 2 meters to provide flow enhancers or resin ducts within the injection region. Only in this manner is it possible to ensure in the case of large components, such as rotor blades of wind turbines or wing shells of aircraft, that the entire component has been infiltrated with the matrix resin. This is because the longer the flow path within the semifinished fiber product is, the greater is the resistance that has to be overcome by the matrix resin, so that corresponding auxiliary means are required in the case of large distances that have to be traversed.

When using flow enhancers, for example a non-woven mat, the entire laminate surface is covered with said mat. The flow enhancer has a lower flow resistance than the laminate and thus provides a distribution of the resin over the area of the entire component, which is then impregnated in the direction of thickness.

The use of a flow enhancer has, however, many disadvantages. For example, the consumption of resin is significantly higher in the case of large components, since resin remains in the flow enhancer after infiltrating the semifinished fiber product. Moreover, the flow enhancer can only be used once, since the resin in the flow enhancer usually cures too. Beyond this, the additional material of the flow enhancer also has to be considered in the design of the component, it not being unknown for the cured flow enhancer to have to be subsequently separated from the finished component. Depending on circumstances, this may lead to damage to the component.

When using resin ducts, ducts are introduced into the semifinished fiber product within the injection region, which is evacuated by means of a pressure sink and which contains the semifinished fiber product, with which ducts the matrix resin is conveyed to the corresponding points within the injection region. The use of resin ducts also has numerous disadvantages, in particular the fact that in the case of large components a large amount of excess resin remains in the resin ducts which, however, can no longer be subsequently cleaned. A significantly increased consumption of resin is likewise created on account of this. Moreover, the resin ducts have to be included in the design considerations, which in particular increases the costs for the provision of the molding tool. On account of the resin channels being non-reusable as a result of the resin residues, such techniques are suitable for serial production only under very specific circumstances.

Alms J. B.; Advani S. G.; Glancey J. L.: “Liquid Composite Molding control methodologies using Vacuum Induced Preform Relaxation”, Composites Part A: Application Science Manufactor 2011:57-65 discloses a method for flow support in the manufacturing of fiber-composite components, in which a vacuum chamber is applied from the outside onto the vacuum film and this part-region is then evacuated, on account of which a lower differential pressure can be set between the fibrous layers and the external environment. As a result, the permeability of the semifinished fiber product is improved endemically, such that in this region the matrix resin infiltrates the corresponding fibrous layers more rapidly. By means of a corresponding sensor device, the vacuum chamber then can be displaced to correspondingly explicit regions in order to provide a corresponding flow enhancement there.

A disadvantage of this method is, however, that the costs are significantly higher on account of the complex design. Moreover, in the first place the method is, in principle, not autoclave-compatible, since the entire installation cannot be operated reliably inside an autoclave. Moreover, this method is unsuitable for very large fiber-composite components, such as, for example, rotor blades or wing shells for aircraft, since such components usually have complex shapes which cannot be adequately reproduced with the installation presented there, and on the other hand the infiltration time would be greatly increased as a result of its application. This, in turn, would however be another significant cost driver.

Against these backgrounds it is an object of the present invention to indicate an improved method and an improved device with which the consumption of resin and the manufacturing costs in particular in the case of large fiber-composite components, such as, for example, rotor blades or wing shells, can be reduced without at the same time compromising the process reliability of the entire manufacturing process.

This object is achieved according to the invention by the method according to Claim 1. The object is also achieved by the device according to Claim 8. Advantageous refinements of the method and of the device are to be found in the corresponding dependent claims.

Accordingly, a method is indicated for achieving the object in which in a step a) at least one elongated hollow object, which is open on one longitudinal side, is provided. Such an elongated hollow object may be, for example, a hollow profile, the end sides of which are closed by a side wall. One longitudinal side of the hollow profile is configured to be open, for example in the form that no side wall is provided on said longitudinal side. Such an elongated hollow object, which is open on one side, may thus for example be an elongated U-shaped profile, on the end sides of which in each case one side wall is provided, which side walls close the U-shaped profile at the end sides.

In the context of the present invention, the term “elongated” in the context of the elongated hollow object means that the longitudinal extent of the hollow object is a multiple of its width, such that a channel-shaped hollow object is formed. The elongated hollow object, which is open on one longitudinal side, should here substantially correspond in its extent to a resin duct used for conveying resin. The elongated hollow object can replace the resin ducts otherwise used.

The term “elongated” does not, however, mean that the hollow object has always to be rectilinear. Far rather, depending on the shape of the component to be manufactured, bends, kinks, and also crossed hollow objects are conceivable. On account of the elongated hollow object, a flow direction of a matrix resin is ultimately predetermined according to the extent of said hollow object.

According to the invention it is now proposed in step b) that this at least one elongated hollow object is arranged with the open longitudinal side on a part-region of the vacuum film outside the injection region and above a part-region of the vacuum film in such a manner that a vacuum-tight cavity is formed between the part-region of the vacuum film which is covered by the hollow object and the hollow object itself. The elongated hollow object here is configured such that it closes the created cavity in a vacuum-tight manner when arranged on the vacuum film.

In this constellation the elongated hollow object is arranged on the vacuum film such that it lies above a specific part-section of the semifinished fiber product which is sealed in a vacuum-tight manner under the vacuum film. Preferably, the at least one elongated hollow object is arranged on the vacuum film such that its position and longitudinal orientation correspond to a potential resin duct for infiltrating the semifinished fiber product with a matrix resin.

In other words, the elongated hollow object is arranged with its open longitudinal side on the vacuum film outside the injection region and above the semifinished fiber product lying under the vacuum film.

Now, in step c) according to the invention, the cavity formed by the arrangement of the elongated hollow object on the vacuum film is evacuated by means of a pressure sink which has a fluid connection to the cavity. Evacuating the cavity preferably takes place after the evacuation of the injection region and/or the semifinished fiber product or also during the same, in order thereby to avoid a shearing of the vacuum film, which could compromise the effect to be brought about.

Evacuating the cavity by means of the pressure sink in step c) here takes place in such a manner that the fiber volume of a fibrous region, which is in operational connection with the evacuated cavity, of the semifinished fiber product is reduced in relation to the other fibrous regions of the semifinished fiber product for the formation of at least one resin flow duct in the semifinished fiber product. This is because evacuating the cavity reduces the pressure differential between the fibrous region of the semifinished fiber product, which is covered by the cavity, and the external environment of this fibrous region, such that the pressure applied to the semifinished fiber product is lowered on account of evacuating the injection region. This leads to the fiber volume being reduced in this endemic fibrous region, which increases the permeability of the semifinished fiber product in this region. By increasing the permeability of the semifinished fiber product in this endemic region, the flow resistance is reduced in relation to the other fibrous regions, which are not covered by an evacuated cavity, such that the effect of a resin flow duct lying in the semifinished fiber product is thereby created.

Fibrous regions which are in operational connection with the evacuated cavity here are those regions of the semifinished fiber product which are covered by the cavity of the hollow object, and the permeability of which is modified on account of evacuating the cavity. In other words, fibrous regions which are in operational connection with the evacuated cavity are those fibrous regions in which the permeability, on account of the evacuation of the corresponding cavity, is modified in relation to other fibrous regions of the semifinished fiber product.

Subsequently, in step d), a matrix resin is injected into the at least one resin flow duct, which has been formed by the evacuation of the cavity, of the semifinished product for the infiltration of the semifinished fiber product with a matrix resin, such that the semifinished fiber product is infiltrated with the matrix resin via the resin flow duct. An injection of the matrix resin into the resin flow duct leads, on account of the lower flow resistance in these fibrous regions, to the resin flow duct formed in the semifinished fiber product being filled with matrix resin, from where the further surroundings, i.e. other adjoining fibrous regions of the semifinished fiber product, can be infiltrated with matrix resin via this resin flow duct.

By means of this invention it is possible to dispense with resin ducts or flow enhancers within the installation, as a result of which the required consumption of resin can be significantly reduced, in particular in the case of large fiber-composite components. Beyond this, on account of dispensing with the aforementioned auxiliary means, a cost reduction in the manufacturing of large fiber-composite components can be achieved without disadvantageously impairing the process reliability of the entire manufacturing process.

After the complete infiltration of the fibrous regions which form the at least one resin flow duct and/or of the complete semifinished fiber product, the hollow objects are preferably opened, such that an ambient pressure is set in the cavity formed by the hollow objects, on account of which no impressions are created in the later component in the regions of the formed resin flow ducts. On account of the opening of the hollow objects and setting the ambient pressure in the cavities, the high differential pressure between internal injection region and external environment is set again, such that the fiber volume in these regions is slowly increased again. This leads to a squeezing of the excess matrix resin from the formed resin flow ducts into the surrounding fibrous regions.

The cavity pressure in the course of evacuating the cavity is advantageously lower than the injection pressure created in the course of evacuating the injection region, both the cavity pressure and the injection pressure being lower than the ambient pressure outside the injection region.

In this manner, a maximum reduction of the fiber volume and increase of the permeability is achieved.

Depending on size and surface area of the fiber-composite component to be manufactured, it is particularly advantageous that a plurality of hollow objects are provided on the vacuum film for the formation of a plurality of resin flow ducts in the semifinished fiber product, such that a complete infiltration of the semifinished fiber product, also in the case of large surface areas to be infiltrated, can be ensured.

In a further advantageous embodiment, a plurality of hollow objects are arranged on the vacuum film in a crosswise pattern in such a manner that the semifinished fiber product is subdivided by the resin flow paths formed by the hollow objects into a plurality of part-regions which are separated by the resin flow paths. On account of the subdivision of the semifinished fiber product into part-regions separated from one another by the resin flow paths, the total volume to be infiltrated is subdivided into a plurality of smaller volumes, which ensures the process reliability with respect to a complete infiltration and, moreover, also reduces the injection period in particular for large fiber-composite components, which constitutes a cost reduction.

It is further advantageous that the cavity pressure is set and adjusted during infiltration such that a rapid advancement of the matrix resin is avoided or reduced. By means of corresponding pressure control, the classic disadvantages of the RTM method can thus be reduced.

In a further advantageous embodiment, the matrix resin, during injection into the formed resin flow ducts, is temperature-controlled by means of a heating element provided in the hollow object, on account of which the viscosity of the matrix resin is reduced and thus the overall flow resistance can be diminished. In this manner, corresponding flow control of the matrix resin in the component can likewise be implemented.

The resin flow ducts, formed by the evacuated cavity, in the semifinished fiber product thus serve to distribute the matrix resin in the semifinished fiber product in order to achieve a complete infiltration of the entire semifinished fiber product in this manner.

On account of the arrangement and evacuation of the hollow objects, the resin flow ducts are formed in such a manner that the matrix resin injected into the resin flow ducts is conveyed for a complete infiltration of the semifinished fiber product.

The invention is explained in more detail in an exemplary manner by means of the appended drawings, in which:

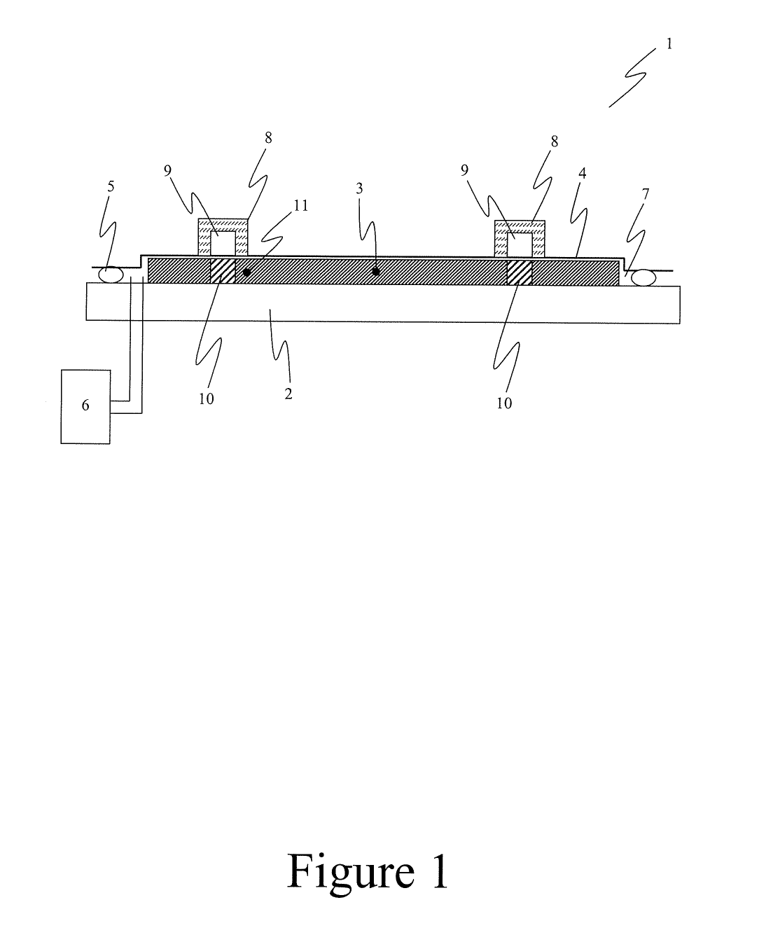

FIG. 1 shows a schematic sectional view of the device according to the invention;

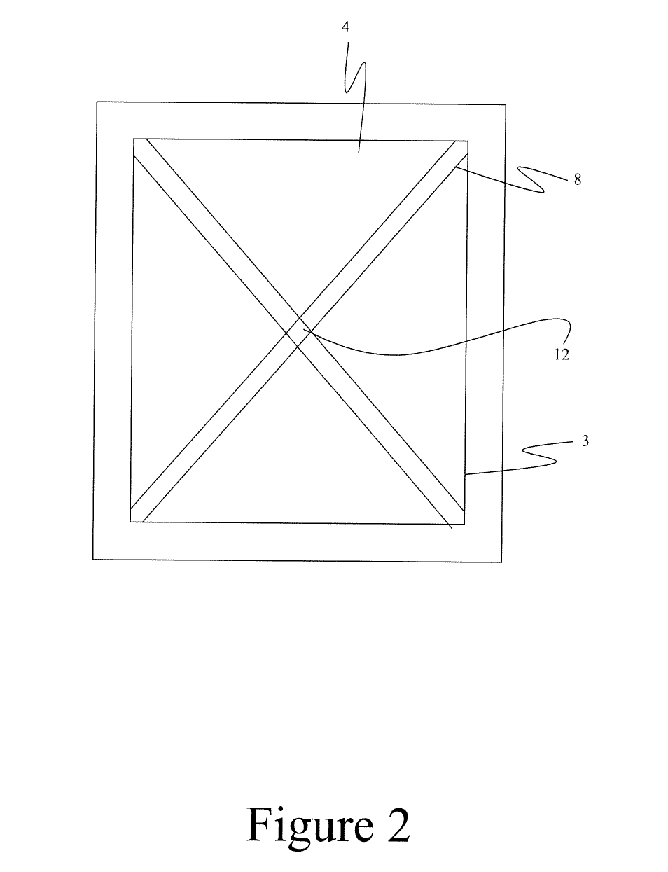

FIG. 2 shows a schematic plan view of the device according to the invention having a crosswise arrangement of the hollow objects.

FIG. 1 shows in a schematic manner the section through the device 1 according to the invention, which has a molding tool 2 for the formation of the shape-imparting structure of the later fiber-composite component. Introduced into the molding tool 2 is a semifinished fiber product 3 which is closed and sealed in a vacuum-tight manner by means of a vacuum film 4 and an outer edge seal 5. The injection region 7 can be evacuated via a first pressure sink 6, such that an injection pressure pᵢ can be set. On account of the evacuation of the injection region 7 via the pressure sink 6, the semifinished fiber product is ultimately also evacuated, whereby air pockets in the fibrous layers are removed.

On the vacuum film 4 there are now arranged elongated hollow objects 8, which are placed on the vacuum film 4 outside the injection region 7. The elongated hollow objects 8 have a U-shaped profile which is closed at the end sides. A cavity 9 is formed by the open longitudinal side, which faces downward, of the elongated hollow object 8, said cavity 9 being in contact with the vacuum film 4 in this region and the inner wall of the hollow object 8. By means of a further pressure sink (not illustrated), this cavity 9 now formed in this manner can also be evacuated, such that a further cavity pressure pₕ can be set here, wherein preferably:

pᵢ>pₕ.

Below the hollow object 8 and the vacuum film 4 in the injection region 7, on account of the evacuation of the cavity 9, a fibrous region 10 of the semifinished fiber product 3 is created which is in operational connection with the evacuated cavity 9. In these fibrous regions of the semifinished fiber product 3, the fiber volume is endemically reduced on account of the evacuated cavity 9, whereby the permeability of this fibrous region 10 is increased. This creates a lower flow resistance when injecting the matrix resin, such that in this manner natural flow paths are formed in the semifinished fiber product 3, with which flow paths the matrix resin can be distributed also in large fiber-composite components without auxiliary means, such as flow enhancers or resin ducts, being necessary for this purpose.

The fibrous regions 10, which are in operational connection with the evacuated cavity, here are endemically limited to the region which is covered by the hollow object 8, such that neighboring regions 11 are not affected. The fibrous regions 10, which are in operational connection with the evacuated cavity 9 in this manner, form a corresponding flow duct or resin flow duct within the semifinished fiber product 3 after complete evacuation of the cavity 9 and setting of the cavity pressure pₕ.

FIG. 2 shows a schematic plan view of the device 1 according to the invention, having the elongated hollow objects 8 which are arranged on a vacuum film 4.

The hollow objects 8 here are arranged on the vacuum film 4 such that they cross one another in a crossing region 12, on account of which the semifinished fiber product 3 lying under the vacuum film 4 is subdivided into a plurality of part-regions. In this manner, the total volume to be infiltrated is subdivided into a plurality of small volumes, which ensures the process reliability with respect to the complete infiltration of the entire semifinished fiber product.

After removing the hollow objects 8 from the vacuum film 4, the matrix resin which has accumulated in the flow ducts 10 is distributed to the surrounding regions, such that no negative residues whatsoever remain in the semifinished fiber product.

A further advantage of this device and the present method is moreover the fact that the entire method is, in principle, autoclave-compatible, since no large and complex installation elements whatsoever are necessary.

1. A method for the manufacturing of a fiber-composite component, in which a semifinished fiber product is inserted into a molding tool and the semifinished fiber product is then closed by a vacuum film in a vacuum-tight manner, such that an injection region with the semifinished fiber product is formed between molding tool and vacuum film, the injection region being evacuated by means of a pressure sink and subsequently being injected with a matrix resin in order to infiltrate the semifinished fiber product in the injection region with the matrix resin, comprising the steps of:
a) providing at least one elongated hollow object which is open on one longitudinal side,
b) arranging the at least one elongated hollow object with the open longitudinal side on a part-region of the vacuum film outside the injection region for the formation of a vacuum-tight cavity between the part-region of the vacuum film which is covered by the hollow object and the hollow object itself,
c) evacuating the cavity by means of a pressure sink, which has a fluid connection to the cavity, in such a manner that the fiber volume of a fibrous region, which is in operational connection with the evacuated cavity, of the semifinished fiber product is reduced in relation to the other fibrous regions of the semifinished fiber product for the formation of at least one resin flow duct in the semifinished fiber product, and
d) injecting the matrix resin into the at least one resin flow duct of the semifinished fiber product such that the semifinished fiber product is infiltrated with the matrix resin via the resin flow duct.

2. A method according to claim 1, wherein after complete infiltration of the fibrous regions, which form at least one resin flow duct, of the semifinished fiber product with the matrix resin, the hollow object is opened in order to set ambient pressure (p₀) in the cavity.

3. A method according to claim 1, wherein in the course of evacuating the cavity a cavity pressure (pₕ) is created which is lower than the injection pressure (pᵢ) created in the course of evacuating the injection region, both the cavity pressure (pₕ) and the injection pressure (pᵢ) being lower than the ambient pressure (p₀) outside the injection region.

4. A method according to claim 1, wherein a plurality of hollow objects are provided on the vacuum film for the formation of a plurality of resin flow ducts in the semifinished fiber product.

5. A method according to claim 1, wherein a plurality of hollow objects are arranged on the vacuum film in a crosswise pattern in such a manner that the semifinished fiber product is subdivided by the resin flow paths formed by the hollow objects into a plurality of part-regions which are separated by the resin flow paths.

6. A method according to claim 1, wherein at least one cavity a cavity pressure (pₕ) is set during infiltration in such a manner that a rapid advancement of the matrix resin is avoided or reduced.

7. A method according to claim 1, wherein the matrix resin in the resin flow ducts is temperature-controlled by means of a heating element provided in the hollow object.

8. A device for the manufacturing of a fiber-composite component, equipped for the implementation of the method of claim 1, having a molding tool, into which a semifinished fiber product can be inserted, having a vacuum film for the vacuum-tight closing of the semifinished fiber product, having a first pressure sink for evacuating the semifinished fiber product and having at least one elongated hollow object, which is open on one side for the formation of a cavity between vacuum film and hollow object in the event that the hollow object is arranged with the open longitudinal side on the vacuum film, wherein by means of a second pressure sink, which has a fluid connection to the cavity, the cavity can be evacuated in order to form resin flow ducts in the semifinished fiber product.

9. A device according to claim 8, wherein a plurality of hollow objects are provided on the vacuum film in a crosswise pattern in such a manner that the semifinished fiber product is subdivided by the resin flow paths formed by the hollow objects into a plurality of part-regions which are separated by the resin flow paths.

10. A device according to claim 8, wherein the hollow object has a heating element for the temperature control of the matrix resin in the resin flow ducts.
